(19) United States
(12) Patent Application Publication
(10) Pub. No.: US 2013/0000974 A1
(43) Pub. Date: Jan. 3, 2013

(54) WIRE HARNESS AND PRODUCTION METHOD THEREFOR

(75) Inventors: Shinichi Igarashi, Yokkaichi-shi (JP); Atsushi Murata, Yokkaichi-shi (JP); Osamu Satou, Yokkaichi-shi (JP); Hiroaki Masuda, Yokkaichi-shi (JP); Nobumasa Takihara, Yokkaichi-shi (JP); Yukihiro Shirafuji, Yokkaichi-shi (JP); Yasushi Atsumi, Yokkaichi-shi (JP)

(73) Assignees: AUTONETWORKS TECHNOLOGIES, LTD, Mie (JP); SUMITOMO ELECTRIC INDUSTRIES, LTD., Osaka (JP); SUMITOMO WIRING SYSTEMS, LTD., Mie (JP)

(21) Appl. No.: 13/583,729

(22) PCT Filed: Oct. 22, 2010
(86) PCT No.: PCT/JP2010/068673

§ 371 Date: Sep. 10, 2012

(30) Foreign Application Priority Data
Apr. 9, 2010 (JP) 2010-090101

(51) Int. Cl. H02G 3/04; B32B 37/00

(52) U.S. Cl. 174/70 R; 156/60

(57) ABSTRACT

A wire harness includes a bundle of electric wires and a protector protecting the bundle of electric wires by extending in a longitudinal direction of the bundle of electric wires and surrounding a portion thereof. The protector includes a base material and a binder material having a lower melting point than the base material, the protector being joined in a joint portion thereof by cooling and solidifying the melted binder material. In a case where a first side portion and a second side portion are each provided as a portion along the longitudinal direction in an outer peripheral surface of the protector and the second side portion is disposed opposite the first side portion with the bundle of electric wires therebetween, a portion of the binder material in each of the first side portion and the second side portion is melted, cooled, and solidified such that the second side portion is harder than the first side portion.

### TECHNICAL FIELD

The present invention relates to a wire harness and a method of producing the same. In particular, the present invention relates to a protector of a wire harness.

### BACKGROUND ART

An exterior material for a wire harness is conventionally known, the exterior material having an inextensible portion and a corrugated portion (e.g., Patent Literature 1). A flexural direction, an amount of flexion, a torsional direction, and an amount of torsion of the exterior material for the wire harness are defined by the inextensible portion and the corrugated portion.

### CITATION LIST

### Patent Literature

Patent Literature 1: Japanese Patent Laid-Open Publication No. 2007-159337

### SUMMARY OF INVENTION

### Technical Problem

A size of the exterior material for the wire harness of Patent Literature 1 (e.g., size in an extending direction of the wire harness) is predetermined. Thus, with exterior materials for wire harnesses required in a plurality of sizes, a problem arises of an increase in procurement cost of exterior materials for wire harnesses.

In view of the above, an object of the present invention is to provide a wire harness that provides good protection of a bundle of electric wires and a method of producing the wire harness.

### Solution to Problem

In order to address the circumstance above, a first aspect provides a wire harness including a bundle of electric wires and a protector protecting the bundle of electric wires by extending in a longitudinal direction of the bundle of electric wires and surrounding a portion thereof. The protector includes a base material and a binder material having a lower melting point than the base material, the protector being joined in a joint portion thereof by cooling and solidifying the melted binder material. In a case where a first side portion and a second side portion are each provided as a portion along the longitudinal direction in an outer peripheral surface of the protector and the second side portion is disposed opposite the first side portion with the bundle of electric wires therebetween, a portion of the binder material in each of the first side portion and the second side portion is melted, cooled, and solidified such that the second side portion is harder than the first side portion.

A second aspect provides the wire harness according to the first aspect, in which the protector is nonwoven fabric including elementary fibers formed of the base material and shaped into a line each and binder fibers formed of the sheath-shaped binder material disposed around the elementary fibers.

A third aspect provides a method of producing a wire harness that includes a bundle of electric wires and a protector, the protector including a base material having a melting point at a first temperature and a binder material having a melting point at a second temperature lower than the melting point of the base material. The method includes (a) a process of surrounding a portion of the bundle of electric wires with the protector extending in a longitudinal direction of the bundle of electric wires; (b) a process of heating the protector that surrounds the portion of the bundle of electric wires by the process (a) at a temperature equal to or higher than the second temperature and lower than the first temperature; and (c) a process of cooling and solidifying the binder material melted by the process (b). In a case where a first side portion and a second side portion are each provided as a portion along the longitudinal direction in an outer peripheral surface of the protector and the second side portion is disposed opposite the first side portion with the bundle of electric wires therebetween, in the process (b), the first side portion is heated at a first treatment temperature which is equal to or higher than the second temperature and lower than the first temperature and the second side portion is heated at a second treatment temperature which is equal to or higher than the second temperature and lower than the first temperature and is higher than the first treatment temperature.

A fourth aspect provides the method of producing the wire harness according to the third aspect, in which in the process (b), the protector that surrounds the portion of the bundle of electric wires by the process (a) is heated at a temperature equal to or higher than the second temperature and lower than the first temperature and additionally is pressurized.

### Advantageous Effects of Invention

According to the wire harness of the first and second aspects and the method of producing the wire harness of the third and fourth aspects, the second side portion is harder than the first side portion. Thus, with an external force exerted on the protector, the protector is readily bent in a state where compressive stress is applied to the first side portion, which is softer than the second side portion, and tensile stress is applied to the second side portion. Specifically, the protector is bent such that the first side portion is formed into a recess and the second side portion is formed into a projection. Accordingly, a flexural direction of the protector can be readily regulated while the bundle of electric wires is protected.

Furthermore, according to the wire harness of the first and second aspects and the method of producing the wire harness of the third and fourth aspects, adjusting meltage in the first and second side portions controls the hardness of the protector. Thus, noise is successfully inhibited from being generated by interference between the protector and another component when the wire harness is mounted.

In addition, according to the wire harness of the first and second aspects and the method of producing the wire harness of the third and fourth aspects, the length of the protector can be easily adjusted in the longitudinal length. This eliminates the necessity to prepare in advance protectors that correspond to various sizes in the longitudinal direction, thus reducing production costs of wire harnesses.

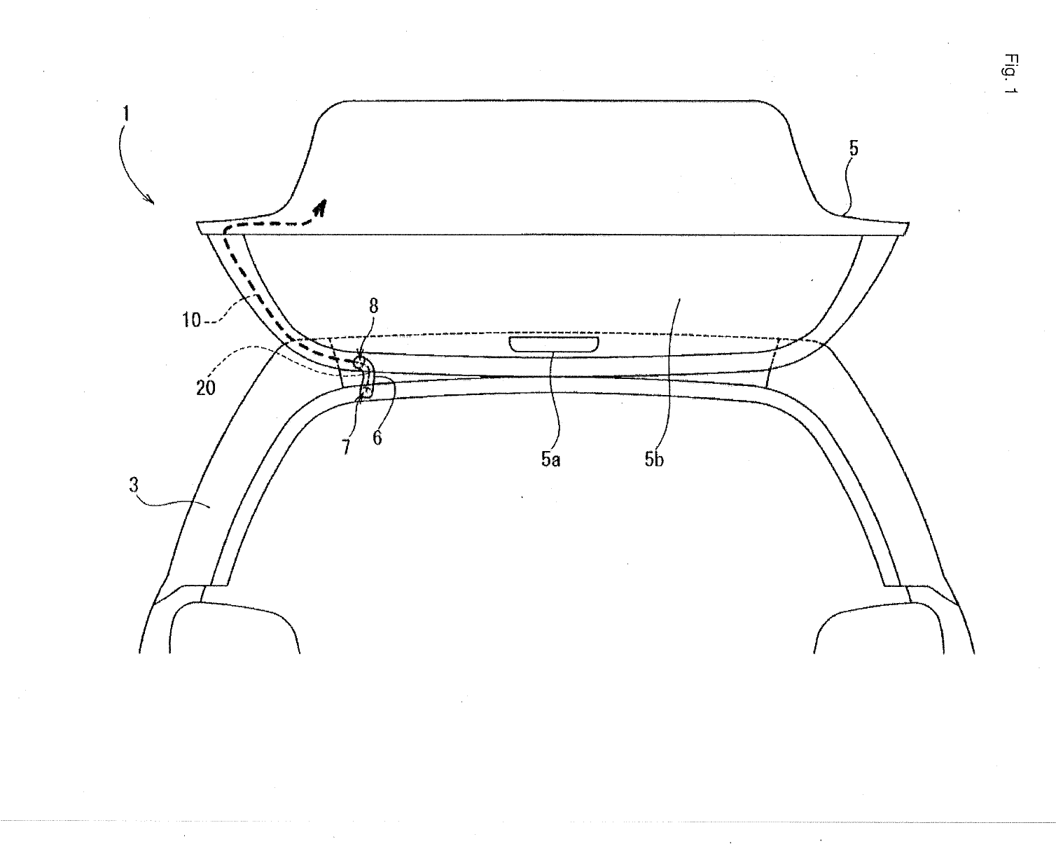

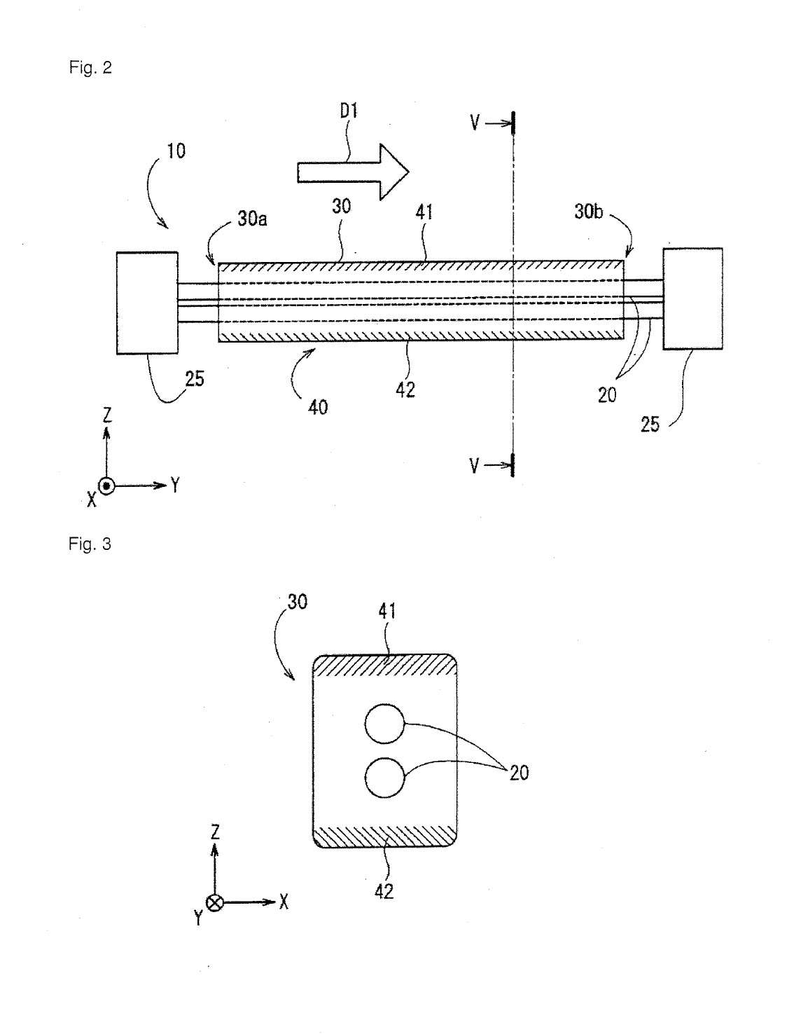

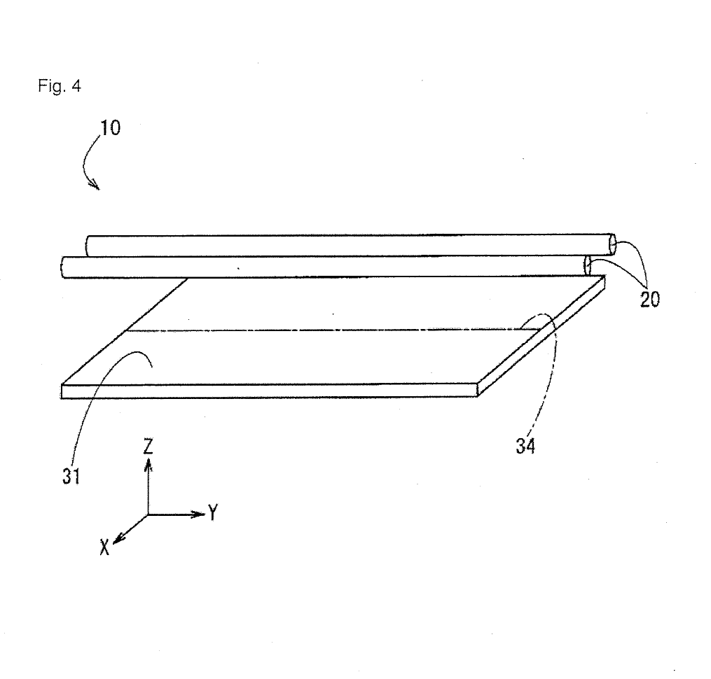

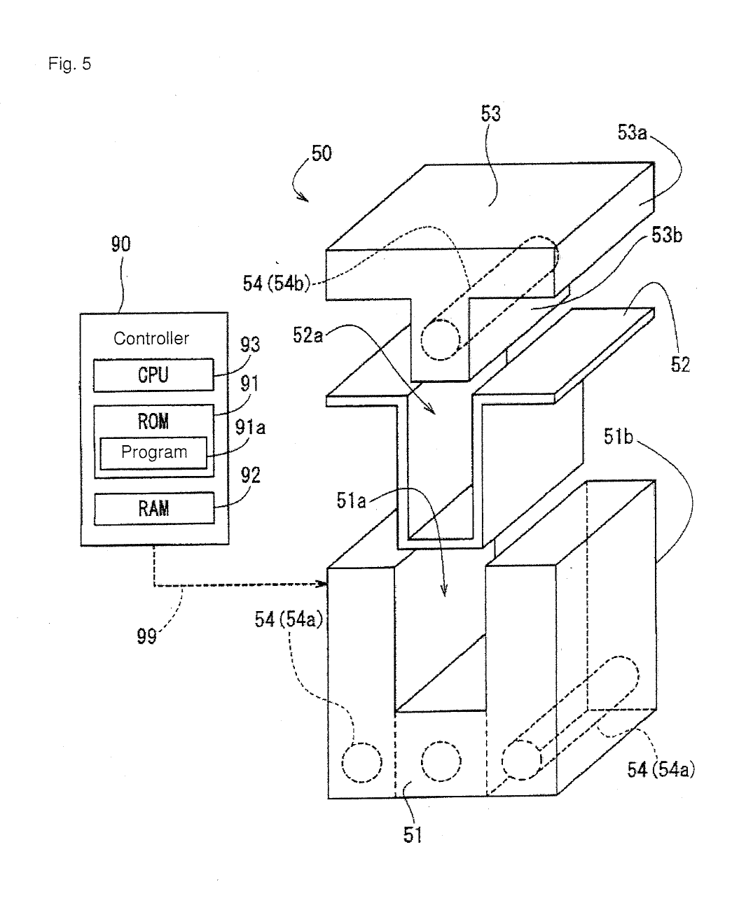

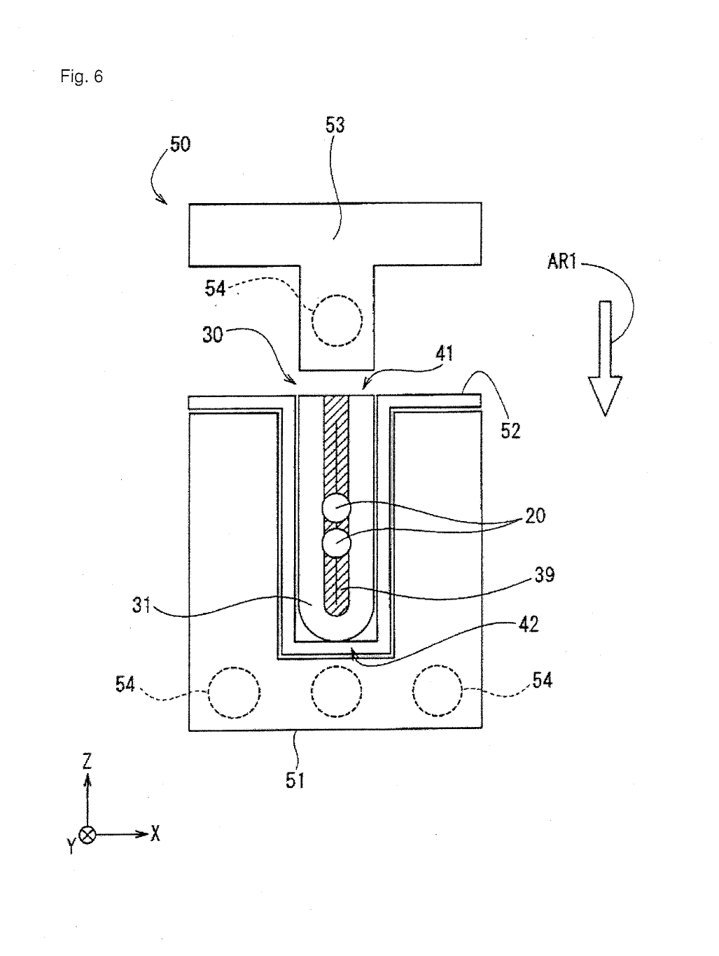

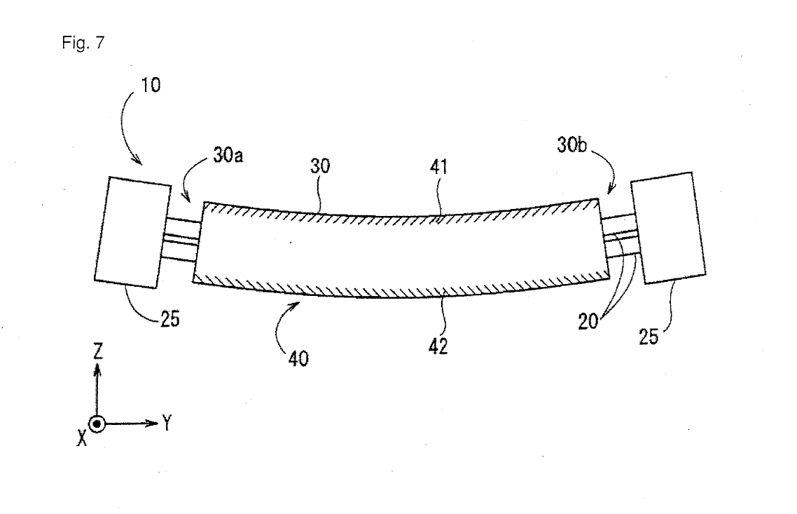

### BRIEF DESCRIPTION OF DRAWINGS

[FIG. 1] FIG. 1 is a rear view illustrating an example of a wire harness routed in an automobile.

[FIG. 2] FIG. 2 is a side view illustrating an exemplary configuration of a wire harness according to an embodiment of the present invention.

[FIG. 3] FIG. 3 is a front cross-sectional view viewed from a line V-V of FIG. 2.

[FIG. 4] FIG. 4 is an exploded perspective view illustrating an exemplary configuration of a protector.

[FIG. 5] FIG. 5 is a front perspective view illustrating an exemplary configuration of a mold used for molding the protector.

[FIG. 6] FIG. 6 is a front view illustrating an exemplary method of producing a wire harness.

[FIG. 7] FIG. 7 is a side view illustrating an exemplary configuration of a wire harness according to an embodiment of the present invention.

### DESCRIPTION OF EMBODIMENTS

An embodiment of the present invention is described in detail below with reference to the drawings.

<1. Configuration of Wire Harness>

FIG. 1 is a rear view illustrating an example of a wire harness 10 routed in an automobile 1. FIG. 2 is a side view illustrating an exemplary configuration of the wire harness 10. FIG. 3 is a front cross-sectional view viewed from a line V-V of FIG. 2. FIG. 4 is an exploded perspective view illustrating an exemplary configuration of a protector 30.

The wire harness 10 is a bundle of a plurality of electric wires 20 and is used for wiring in the automobile 1. With reference to FIG. 1, for instance, the wire harness 10 of the present embodiment electrically connects a vehicle body 3 and a back door 5 of the automobile 1. With reference to FIG. 2, the wire harness 10 mainly includes a plurality of (two or more; FIG. 2 shows two wires for illustration purposes) electric wires 20 and a protector 30.

As shown in FIG. 1, a grommet 6 is provided between a through-hole 7 of the vehicle body 3 and a through-hole 8 of the back door 5 and is formed of rubber, for example. The wire harness 10 is inserted inside the grommet 6, as shown in FIG. 1. Thus, the wire harness 10 disposed between the through-hole 7 of the vehicle body 3 and the through-hole 8 of the back door 5 is protected by the grommet 6.

The plurality of electric wires 20 (electric wire bundle) is used for, for example, electric connection with an electric component (e.g., a stop lamp 5a mounted proximate to an upper portion of the back door 5; refer to FIG. 1) of the automobile 1. With reference to FIG. 2, connectors 25 for connection are provided to both ends of the plurality of electric wires 20.

The protector 30 extends in a longitudinal direction D1 (±Y-axis direction in FIG. 2) of the plurality of electric wires 20 and surrounds a portion of each electric wire 20 to protect each electric wire 20. In the present embodiment, the protector 30 is formed of one sheet of nonwoven fabric 31, as shown in FIG. 4. The nonwoven fabric 31 is mainly composed of elementary fibers formed of PET (polyethylene terephthalate: base material) and shaped into a line each and binder fibers formed of a sheath-shaped binder material disposed around the elementary fibers.

The binder material used in the present embodiment is formed of a copolymer of PET and PEI (polyethylene isophthalate). A melting point of the binder material (second temperature) is 110 to 150° C., which is defined so as to be lower than that of the base material (a melting point of PET: approximately 250° C. (first temperature)).

<2. Method of Producing Wire Harness>

FIG. 5 is a front perspective view illustrating an exemplary configuration of a mold 50 used for molding the protector 30. FIG. 6 is a front view illustrating a method of producing the wire harness 10. First, a hardware configuration of the mold 50 is described below, and then the method of producing the wire harness 10 is described.

<2.1. Configuration of Mold>

The hardware configuration of the mold 50 is described below. The mold 50 heats and pressurizes one sheet of nonwoven fabric 31 (refer to FIG. 6) so as to mold the nonwoven fabric 31 into the protector 30 having a desired shape. With reference to FIG. 5, the mold 50 mainly includes a holder 51, a support plate 52, a compressor 53, and heaters 54.

The holder 51 heats the nonwoven fabric 31 inserted in the support plate 52. A holding space 51a is a space defined by side walls 51b of the holder 51. The support plate 52 is held by the holder 51 in a state of being fitted in the holding space 51a.

The support plate 52 houses the nonwoven fabric 31 to be heated and pressurized, as shown in FIG. 6. The nonwoven fabric 31 is folded along a folding line 34 (refer to FIG. 4), for example, and is then inserted into a placement space 52a and housed in the support plate 52.

The compressor 53 is a pressurizing component that applies pressure to the nonwoven fabric 31 inserted in the placement space 52a. The compressor 53 mainly includes a flat portion 53a and an insertion portion 53b, as shown in FIG. 6.

Each of the flat portion 53a and the insertion portion 53b is a substantially rectangular parallelepiped block. As shown in FIGS. 5 and 6, the insertion portion 53b is provided to one side surface of the flat portion 53a. The insertion portion 53b can be inserted into the placement space 52a of the support plate 52. Thus, inserting the insertion portion 53b of the compressor 53 into the placement space 52a pressurizes the nonwoven fabric 31 held by the support plate 52 (refer to FIG. 6).

The heaters 54 (54a and 54b) are heating components that heat the nonwoven fabric 31 inserted in the placement space 52a. As shown in FIGS. 5 and 6, the holder heaters 54a are embedded in the side walls 51b and the compressor heater 54b is embedded in the insertion portion 53b. The heaters 54 (54a and 54b) are electrically connected to a controller 90 through a signal line 99.

With reference to FIG. 6, driving the compressor heater 54b thus heats a first side portion 41 of the protector 30, while driving the holder heaters 54a heats a second side portion 42 of the protector 30.

The first and second side portions 41 and 42 are provided respectively as portions along the longitudinal direction D1 in an outer peripheral surface 40 of the protector 30, as shown in FIG. 2. The second side portion 42 is provided opposite the first side portion 41 with the plurality of electric wires 20 therebetween, as shown in FIGS. 2 and 3.

The controller 90 performs, for example, control of heating by the heaters 54 (54a and 54b) and data calculation. As shown in FIG. 5, the controller 90 mainly includes a ROM 91, a RAM 92, and a CPU 93.

The ROM (Read Only Memory) 91 is a so-called nonvolatile memory and stores a program 91a, for example. The ROM 91 may be a flash memory, which is a readable and writable nonvolatile memory. The RAM (Random Access Memory) 92 is a volatile memory and stores data used in calculation by the CPU 93, for example. The CPU (Central Processing Unit) 93 executes control based on the program 91a of the ROM 91 (e.g., control of heating to the nonwoven fabric 31) and data calculation.

<2.2. Method of Producing Wire Harness Using Mold>

A method of producing the wire harness 10 using the mold 50 is described with reference to FIGS. 4 to 6.

In the method of producing the wire harness 10, the nonwoven fabric 31 is first folded centered on the folding line 34 (refer to FIG. 4), and thus the plurality of electric wires 20 are interposed between the nonwoven fabric 31. Then, the plurality of electric wires 20 and the nonwoven fabric 31 are inserted into the placement space 52a of the support plate 52. Thus, a portion of the plurality of electric wires 20 is surrounded by the nonwoven fabric 31 extending in the longitudinal direction D1 (refer to FIG. 2), and the protector 30 is provided in a pre-heating and pre-pressurizing state.

Subsequently, the holder and compressor heaters 54a and 54b are driven by the controller 90. Then, the protector 30 is heated at a temperature equal to or higher than the melting point (second temperature) of the binder material of the nonwoven fabric 31 and lower than the melting point (first temperature) of the base material of the nonwoven fabric 31. In addition to the heating treatment, the protector 30 is pressurized in a direction of an arrow AR1 (compressing direction; refer to FIG. 6) by the compressor 53. Thus, the binder material of the nonwoven fabric 31 is melted.

Then, the heating by the heaters 54 is stopped and the protector 30 is cooled by air and the like. Thus, a portion or all of the binder material in a joint portion 39 is melted and spread into the base material, and is then cooled and solidified. Thereby, the protector 30 is joined at the joint portion 39 thereof. Similar to the joint portion 39, a portion or all of the binder material in the first and second side portions 41 and 42 is also melted and then cooled and solidified.

In the present embodiment, operation of the heaters 54 (54a and 54b) is controlled, and thus an amount of heat transferred to the first and second side portions 41 and 42 is controlled. Accordingly, meltage of the binder material in the second side portion 42 is greater than meltage of the binder material in the first side portion 41. For example, the first side portion 41 is heated at a first treatment temperature which is equal to or higher than the melting point of the binder material and lower than the melting point of the base material, while the second side portion 42 is heated at a second treatment temperature which is equal to or higher than the melting point of the binder material and lower than the melting point of the base material as well as being higher than the first treatment temperature.

Thereby, the binder material in the first and second side portions 41 and 42 is melted and then cooled and solidified such that the second side portion 42 is harder than the first side portion 41. Thus, with an external force exerted on the protector 30, the protector 30 is readily bent in a state where compressive stress is applied to the first side portion 41, which is softer than the second side portion 42, and tensile stress is applied to the second side portion 42. Specifically, the protector 30 is bent such that the first side portion 41 is formed into a recess and the second side portion 42 is formed into a projection (refer to FIG. 6).

Accordingly, the wire harness 10 can readily control the flexural direction of the protector 30 while protecting the plurality of electric wires 20.

For instance, in a case where the wire harness 10 is inserted through the through-hole 8 of the back door 5 (refer to FIG. 1) such that the first side portion 41 is disposed on a rear glass 5b side of the back door 5, the wire harness 10 is readily bent along a curve line of the back door 5. This reduces a work load of a worker who inserts the wire harness 10 into the through-hole 8.

In addition, the meltage in the first and second side portions 41 and 42 is adjusted by the controller 90, and thus the hardness of the protector 30 can be controlled. This successfully inhibits noise from being generated by interference between the protector 30 and another component when the wire harness 10 is mounted in the automobile 1. Furthermore, the protector 30 can be produced so as to have a hardness that allows easy insertion into the through-hole 7 of the vehicle body 3 and the through-hole 8 of the back door 5 (refer to FIG. 1).

In addition, the protector 30 is formed of the nonwoven fabric 31, and thus the length of the protector 30 can be easily adjusted in the longitudinal direction D1. In other words, the nonwoven fabric 31 is cut into a required size when needed to produce protectors 30 in various sizes. This eliminates the necessity to prepare in advance protectors 30 that correspond to various sizes in the longitudinal direction D1, thus reducing production costs of wire harnesses.

<3. Advantages of Wire Harness of Present Embodiment>

As described above, in the wire harness 10 of the present embodiment, the meltage of the binder material is greater in the second side portion 42 than in the first side portion 41 and the second side portion 42 is harder than the first side portion 41. Thus, with an external force exerted on the protector 30, the protector 30 is bent such that the first side portion 41 is formed into a recess and the first side portion 41 is formed into a projection. Accordingly, the flexural direction of the protector 30 can be readily controlled while the plurality of electric wires 20 is protected.

<4. Modifications>

The embodiment of the present invention was described above. The present invention, however, is not limited to the above embodiment and may be modified in various ways.

(1) In the present embodiment, the wire harness 10 has the plurality of electric wires 20. The number of electric wires 20 is not limited to this. For example, even in a case where the wire harness 10 has one electric wire 20, the wire harness 10 exhibits a function similar to the wire harness 10 having the plurality of electric wires 20.

(2) In the present embodiment, the protector 30 is molded into a desired shape by placing the plurality of electric wires 20 inside one sheet of nonwoven fabric and then heating and pressurizing the nonwoven fabric. A method of molding the protector 30 is not limited to the method above. The protector 30 may be molded, for example, by placing a plurality of electric wires 20 between two sheets of nonwoven fabric and then heating and pressurizing the two sheets of nonwoven fabric. Furthermore, the protector 30 may be formed of three or more sheets of nonwoven fabric.

(3) In the present embodiment, the wire harness 10 is inserted through the through-hole 8 of the back door 5. The placement of the wire harness 10 is not limited to this. For example, the wire harness 10 may be placed proximate to a mounting position of an instrument panel and a steering wheel. In this case, the wire harness 10 can be bent in one direction to secure a gap for vehicle components.

### REFERENCE SIGNS LIST

1: Automobile
3: Vehicle body
5: Back door
10: Wire harness
20: Electric wire
30: Protector
31: Nonwoven fabric
34: Folding line
39: Joint portion
40: Outer peripheral surface
41: First side portion
42: Second side portion
50: Mold
51: Holder
52: Support plate
53: Compressor
54: Heater
90: Controller
D1: Longitudinal direction

1. A wire harness comprising:
(a) a bundle of electric wires; and
(b) a protector protecting the bundle of electric wires by extending in a longitudinal direction of the bundle of electric wires and surrounding a portion thereof,
the protector comprising:
(b-1) a base material; and
(b-2) a binder material having a lower melting point than the base material, the protector being joined in a joint portion thereof by cooling and solidifying the melted binder material, wherein
in a case where a first side portion and a second side portion are each provided as a portion along the longitudinal direction in an outer peripheral surface of the protector and the second side portion is disposed opposite the first side portion with the bundle of electric wires therebetween, a portion of the binder material in each of the first side portion and the second side portion is melted, cooled, and solidified such that the second side portion is harder than the first side portion.

2. The wire harness according to claim 1, wherein the protector is nonwoven fabric comprising:
elementary fibers formed of the base material and shaped into a line each; and
binder fibers formed of the sheath-shaped binder material disposed around the elementary fibers.

3. A method of producing a wire harness that comprises a bundle of electric wires and a protector,
the protector comprising:
a base material having a melting point at a first temperature; and
a binder material having a melting point at a second temperature lower than the melting point of the base material, the method comprising:
(a) a process of surrounding a portion of the bundle of electric wires with the protector extending in a longitudinal direction of the bundle of electric wires;
(b) a process of heating the protector that surrounds the portion of the bundle of electric wires by the process (a) at a temperature equal to or higher than the second temperature and lower than the first temperature; and
(c) a process of cooling and solidifying the binder material melted by the process (b), wherein
in a case where a first side portion and a second side portion are each provided as a portion along the longitudinal direction in an outer peripheral surface of the protector and the second side portion is disposed opposite the first side portion with the bundle of electric wires therebetween, in the process (b), the first side portion is heated at a first treatment temperature which is equal to or higher than the second temperature and lower than the first temperature and the second side portion is heated at a second treatment temperature which is equal to or higher than the second temperature and lower than the first temperature and is higher than the first treatment temperature.

4. The method of producing the wire harness according to claim 3, wherein, in the process (b), the protector that surrounds the portion of the bundle of electric wires by the process (a) is heated at a temperature equal to or higher than the second temperature and lower than the first temperature and additionally is pressurized.
